(19) United States
(12) Patent Application Publication
(10) Pub. No.: US 2025/0282084 A1
(43) Pub. Date: Sep. 11, 2025

(54) Extruded Polystyrene Processing Device

(71) Applicant: Keith Utter, McCordsville, IN (US)

(72) Inventor: Keith Utter, McCordsville, IN (US)

(21) Appl. No.: 18/598,917

(22) Filed: Mar. 7, 2024

(51) Int. Cl. B29B 17/04; B29K 25/00

(52) U.S. Cl. CPC B29B 17/0412; B29B 2017/0416; B29B 2017/0436; B29B 2017/044; B29K 2025/06

(57) ABSTRACT

An extruded polystyrene processing device for processing extruded polystyrene includes a processing plant which includes a chopping unit for chopping extruded polystyrene into chopped pieces. The chopping unit is connected to a solvent bath unit for submerging the chopped pieces in a solvent for eliminating air bubbles in the chopped pieces. The solvent bath unit is connected to a conveyor unit for rinsing the chopped pieces and the conveyor unit is connected to a freezing unit to subsequently freeze the chopped pieces. The freezing unit is connected to a grinding unit for grinding the frozen chopped pieces into a granular material for subsequent collection and transportation to a waste management facility. In this way the processing plant reduces the total volume of the extruded polystyrene prior to being handled by the waste management facility.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to polystyrene processing devices and more particularly pertains to a new polystyrene processing device for reducing the total volume of extruded polystyrene prior to being handled by a waste management facility. The device includes a processing plant which includes a chopping unit for chopping items of extruded polystyrene into chopped pieces and a solvent bath unit for reducing the chopped pieces and a conveyor unit for rinsing the chopped pieces and a freezing unit for freezing the chopped pieces and a grinding unit for grinding the chopped pieces into a granular material.

### (2) Description of Related Art Including Information Disclosed Under 37 CFR 1.97 and 1.98

The prior art relates to polystyrene processing devices including a variety of polystyrene processing devices that mechanically process polystyrene into a crushed product and a polystyrene processing device that employs a solvent to reduce polystyrene into a sludge and a variety of polystyrene processing devices that each at least employs a solvent for reducing the volume of polystyrene. In no instance does the prior art disclose a polystyrene processing device that includes a chopper for chopping items of extruded polystyrene and a solvent bath for reducing the chopped extruded polystyrene and a grinding unit for grinding the reduced polystyrene into a granular material to reduce the overall volume of the polystyrene.

### BRIEF SUMMARY OF THE INVENTION

An embodiment of the disclosure meets the needs presented above by generally comprising a processing plant which includes a chopping unit for chopping extruded polystyrene into chopped pieces. The chopping unit is connected to a solvent bath unit for submerging the chopped pieces in a solvent for eliminating air bubbles in the chopped pieces. The solvent bath unit is connected to a conveyor unit for rinsing the chopped pieces and the conveyor unit is connected to a freezing unit to subsequently freeze the chopped pieces. The freezing unit is connected to a grinding unit for grinding the frozen chopped pieces into a granular material for subsequent collection and transportation to a waste management facility. In this way the processing plant reduces the total volume of the extruded polystyrene prior to being handled by the waste management facility.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an extruded polystyrene processing device according to an embodiment of the disclosure.

FIG. 2 is a left side phantom view of an embodiment of the disclosure.

FIG. 3 is a magnified detail view taken from circle 3 of FIG. 2 of an embodiment of the disclosure showing a water lift plate in a second position.

FIG. 4 is a magnified phantom view taken from circle 4 of FIG. 2 of an embodiment of the disclosure showing chopped pieces being deposited into a solvent bath unit.

FIG. 5 is a magnified phantom view taken from circle 5 of FIG. 2 of an embodiment of the disclosure showing a solvent lift panel being urged into a vertical position.

FIG. 6 is a top view of a freezer unit of an embodiment of the disclosure.

FIG. 7 is a top perspective view of a tray of an embodiment of the disclosure.

FIG. 8 is a logic tree view of an embodiment of the disclosure.

FIG. 9 is a schematic view of an embodiment of the disclosure.

### DETAILED DESCRIPTION OF THE INVENTION

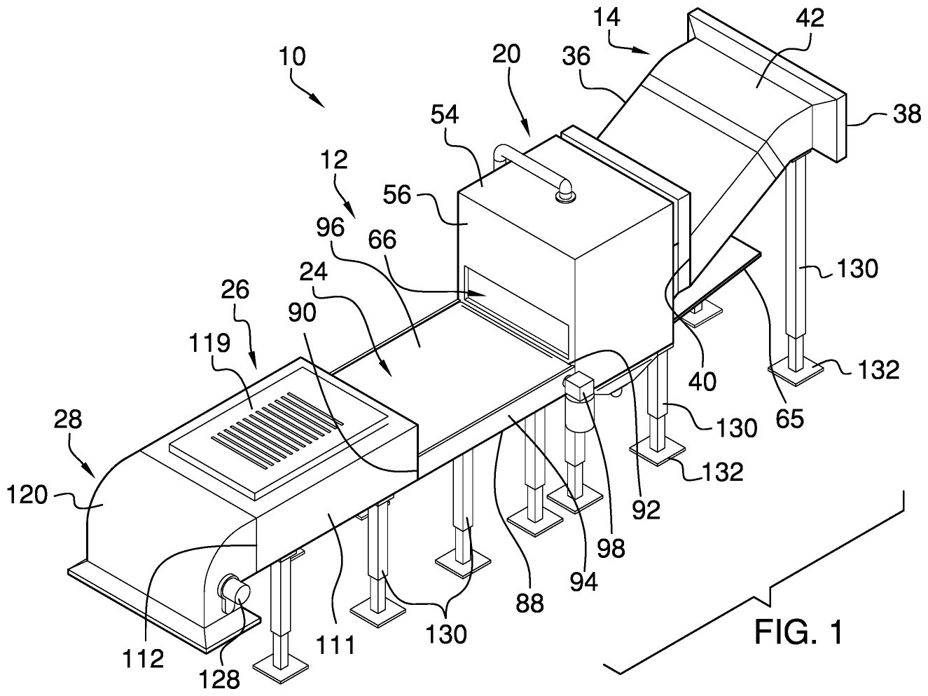

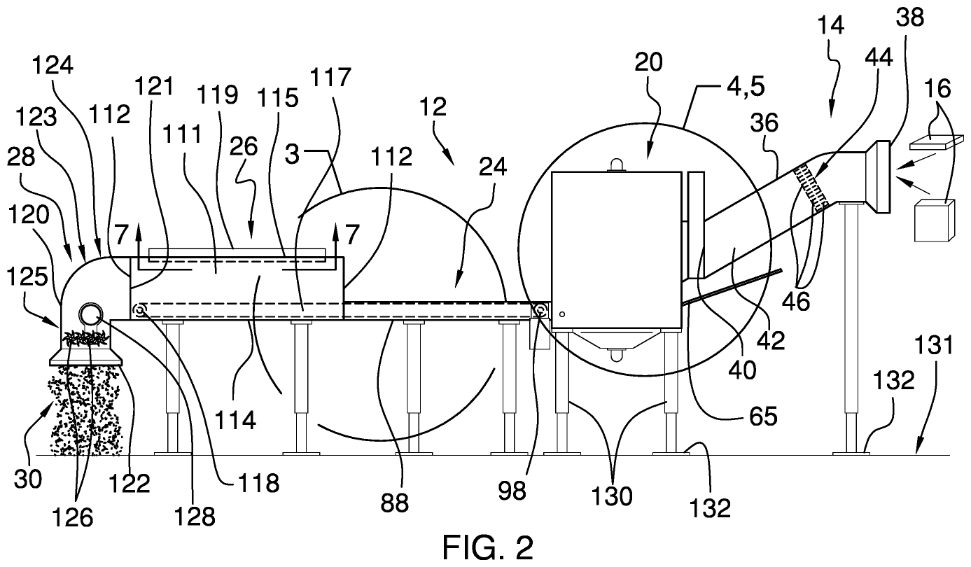

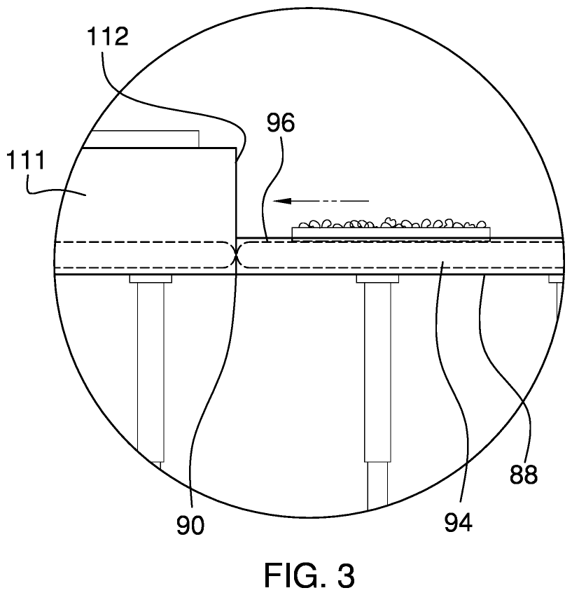

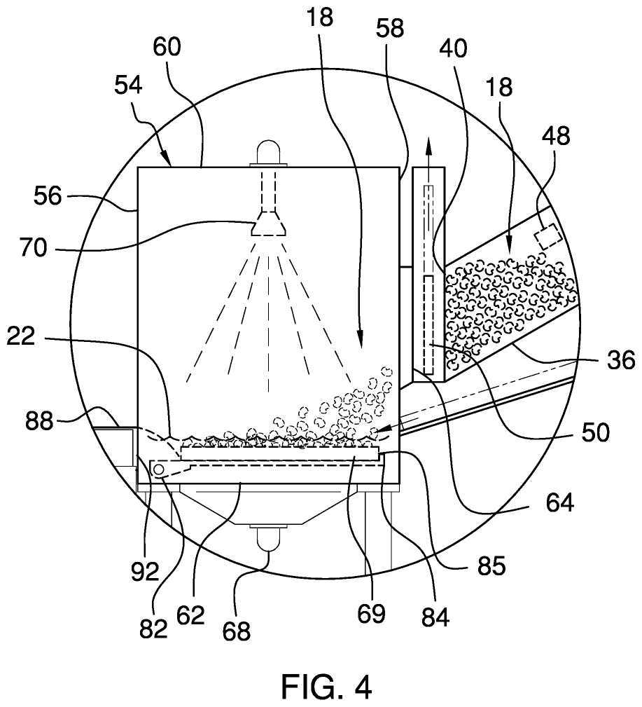

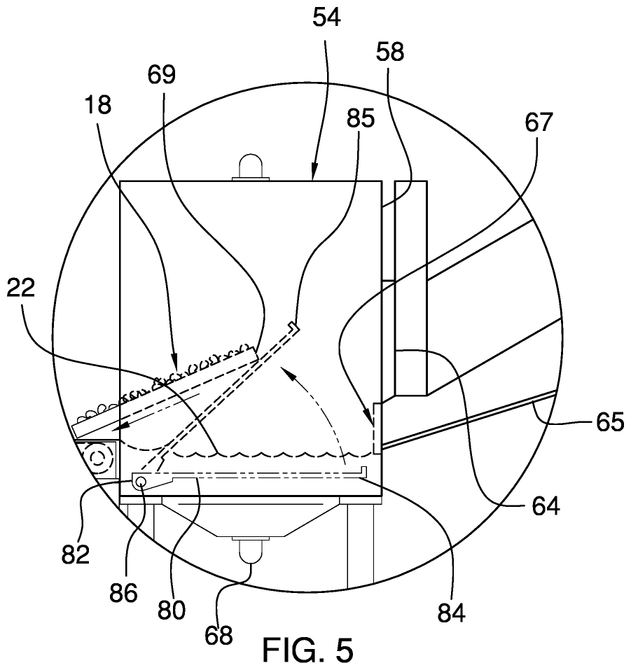

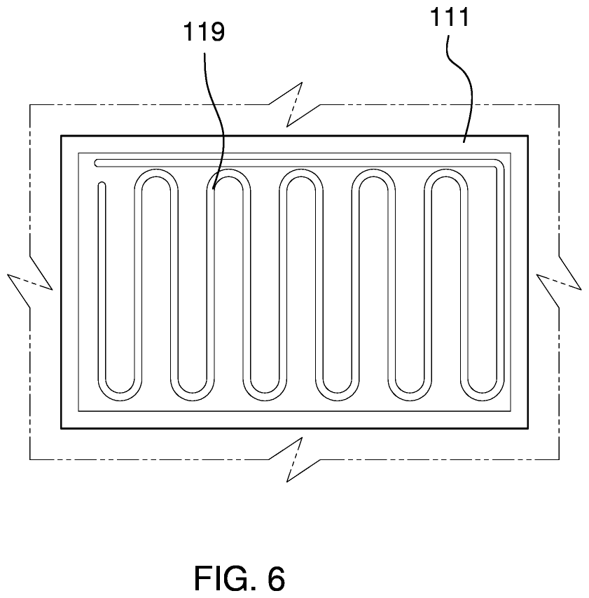

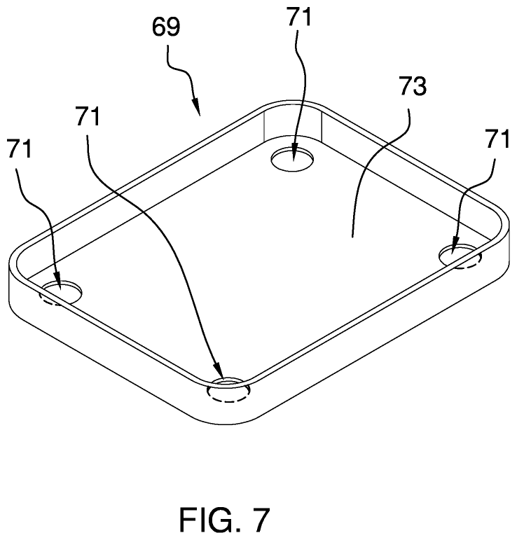

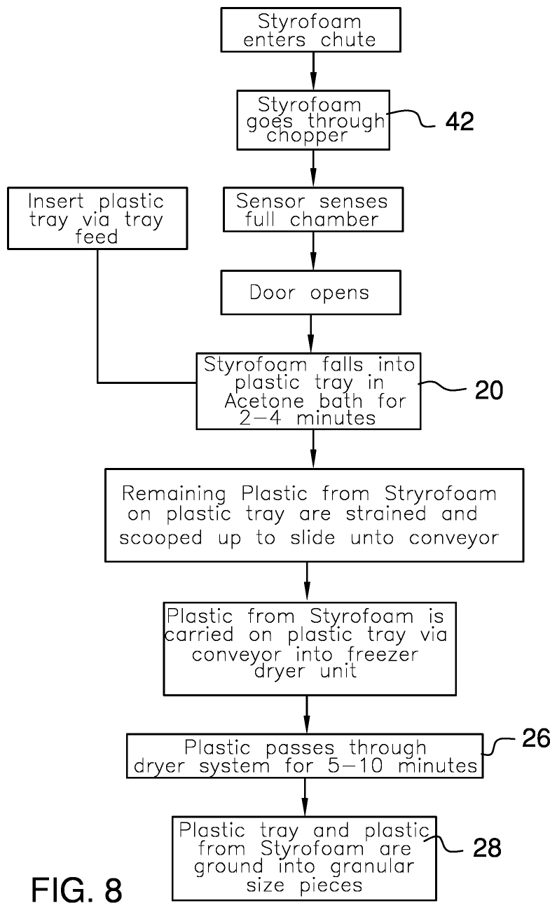

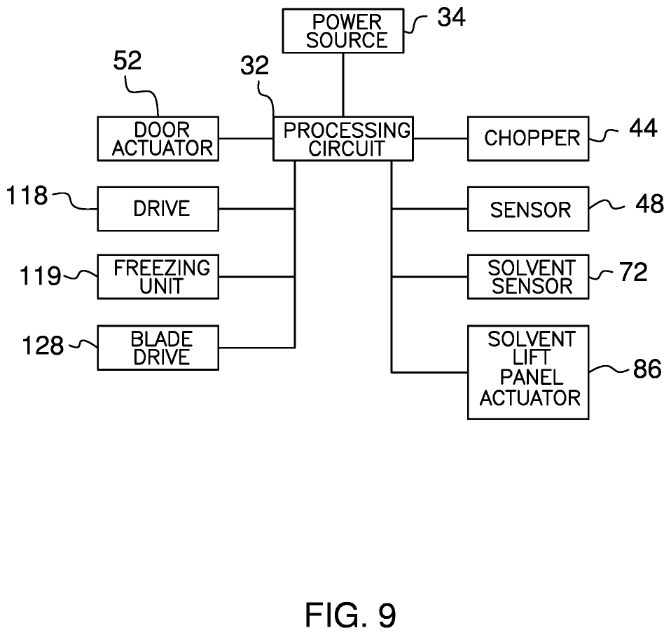

With reference now to the drawings, and in particular to FIGS. 1 through 9 thereof, a new polystyrene processing device embodying the principles and concepts of an embodiment of the disclosure and generally designated by the reference numeral 10 will be described.

As best illustrated in FIGS. 1 through 9, the extruded polystyrene processing device 10 generally comprises a processing plant 12 which includes a chopping unit 14 for chopping items of extruded polystyrene 16 into chopped pieces 18. The chopping unit 14 is connected to a solvent bath unit 20 for submerging the chopped pieces 18 in a solvent 22 for eliminating air bubbles in the chopped pieces 18. The solvent bath unit 20 is connected to a conveyor unit 24 which receives the chopped pieces 18 for rinsing the solvent 22 from the chopped pieces 18. Additionally, the conveyor unit 24 is connected to a freezing unit 26 which receives the chopped pieces 18 to subsequently freeze the chopped pieces 18. The freezing unit 26 is connected to a grinding unit 28 which receives the heated and dried chopped pieces 18 for grinding the heated and dried chopped pieces 18 into a granular material 30 for subsequent collection and transportation to a waste management facility. In this way the processing plant 12 reduces the total volume of the items of extruded polystyrene 16 prior to being handled by the waste management facility thereby reducing the environmental impact of the extruded polystyrene 16. Furthermore, the waste management facility may be a landfill, a waste incineration facility or any other kind of waste management facility that commonly deals with both residential and commercial waste.

The processing plant 12 includes a processing circuit 32 and the processing circuit 32 receives a chop input, a door open input, a door close input, a compress input, a solvent lift input, a conveyor input, a freezing actuate input, a freezing de-actuate input and a grinding input. Additionally, the processing circuit 32 is electrically coupled to a power source 34 which may comprise an electrical system of the facility in which the processing plant 12 is stationed. The chopping unit 14 comprises a hopper 36 which has a first end 38, a second end 40 and an outer wall 42 extending between the first end 38 and the second end 40. The hopper 36 is substantially hollow and each of the first end 38 and the second end 40 is open. The outer wall 42 undulates between the first end 38 and the second end 40 such that the hopper 36 defines an S-shape having the first end 38 being spaced upwardly from the second end 40. In this way the first end 38 can receive items of extruded polystyrene 16 such that the undulation of the outer wall 42 facilitates the items of extruded polystyrene 16 to be gravity fed toward the second end 40.

The chopping unit 14 includes a chopper 44 that is movably integrated within the hopper 36 and the chopper 44 is electrically coupled to the processing circuit 32. The chopper 44 is turned on when the processing circuit 32 receives the chop input and the chopper 44 is positioned closer to the first end 38 than the second end 40. The chopper 44 includes a series of blades 46 which are rotated when the chopper 44 is turned on thereby facilitating the chopper 44 to chop the items of extruded polystyrene 16 into the chopped pieces 18. The chopper 44 may comprise an electric motor or the like and the series of blades 46 may be cylindrical blades that are arranged in a row and which are each driven by the electric motor. Additionally, the chopper 44 may be engineered to produce chopped pieces which have a maximum length and width ranging between approximately 5.0 cm and 8.0 cm.

The chopping unit 14 includes a sensor 48 which is positioned within the hopper 36 and the sensor 48 is positioned closer to the second end 40 of the hopper 36 than the chopper 44. The sensor 48 is electrically coupled to the processing circuit 32 and the sensor 48 senses the volume of chopped pieces 18 in the hopper 36. Furthermore, the processing circuit 32 receives the door open input when the sensor 48 determines that the volume of the chopped pieces 18 in the hopper 36 exceeds a pre-determined trigger volume. The pre-determined trigger volume may be a volume of approximately 80.0 percent of the internal area in the hopper 36 which is located between the chopper 44 and the second end 40 of the hopper 36. Furthermore, the processing circuit 32 receives the door close input when the sensor determines that the volume of the chopped pieces 18 in the hopper 36 does not exceed the pre-determined trigger volume.

The chopping unit 14 includes a door 50 which is slidably integrated into the second end 40 of the hopper 36 and the door 50 is oriented to lie on a plane that is oriented parallel to the second end 40 of the hopper 36. The door 50 is positionable in a closed position having the door 50 lying against the second end 40 for closing the second end 40 thereby inhibiting the chopped pieces 18 from passing through the second end 40 and exiting the hopper 36. The door 50 is positionable in an open position having the door 50 being lifted upwardly to expose the second end 40 thereby facilitating the chopped pieces 18 to pass through the second end 40 to exit the hopper 36.

The chopping unit 14 includes a door actuator 52 which is integrated into the hopper 36. The door actuator 52 is electrically coupled to the processing circuit 32 and the door actuator 52 is in mechanical communication with the door 50. The door actuator 52 is actuated into a closing condition when the processing circuit 32 receives the door close input thereby urging the door 50 into the closed position. Conversely, the door actuator 52 is actuated into an open condition when the processing circuit 32 receives the door open input thereby urging the door 50 into the open position. The door actuator 52 may be an electric motor or other type of electromechanical actuator that can generate rotational torque in two directions.

The solvent bath unit 20 comprises a solvent housing 54 that has a front wall 56, a back wall 58, a top wall 60 and a bottom wall 62. The solvent housing 54 has an entrance 64 extending through the back wall 58 and the solvent housing 54 has an exit 66 extending through the front wall 56; each of the exit 66 and the entrance 64 is spaced upwardly from the bottom wall 62. The second end 40 of the hopper 36 is attached to the back wall 58 of the solvent housing 54 having the second end 40 being aligned with the entrance 64. In this way the chopped pieces 18 can pass through the entrance 64 when the door 50 is urged into the open position.

The solvent housing 54 has a drain 68 which is integrated into the bottom wall 62 thereby facilitating the drain 68 to drain the solvent 22 which is contained in the solvent housing 54. The solvent 22 is filled to a level that is below each of the entrance 64 and the exit 66 in the solvent housing 54 thereby facilitating the solvent housing 54 to contain the solvent 22. Additionally, the solvent housing 54 has a spray nozzle 70 extending through the top wall 60 of the solvent housing 54. The spray nozzle 70 is in fluid communication with the drain 68 thereby facilitating the spray nozzle 70 to spray the solvent 22 into the solvent housing 54 for recirculating the solvent 22 in the solvent housing 54. The solvent 22 may be acetone or other type of organic solvent that is capable of dissolving extruded polystyrene thereby releasing air bubbles in the extruded polystyrene and the spray nozzle 70 may include a fluid pump for pumping the solvent 22 through the spray nozzle 70.

The solvent bath unit 20 includes a tray ramp 65 that is coupled to and angles upwardly and rearwardly from the back wall 58 of the solvent housing 54. Additionally, the tray ramp 65 is aligned with a tray opening 67 in the back wall 58 of the solvent housing 54 thereby facilitating a tray 69 which is placed on the tray ramp 65 to slide through the tray opening 67 and into the solvent housing 54 such that the chopped pieces 18 are deposited into the tray 69. Additionally, the tray opening 67 is positioned beneath the entrance 64 in the solvent housing 54. The tray 69 has a plurality of drain holes 71 each extending through a bottom wall 73 of the tray 69 thereby facilitating the solvent 22 to drain through each of the plurality of drain holes 71. Furthermore, the tray 69 may be comprised of recycled plastic or other type of material that can be chopped or ground up by grinding blades.

The solvent bath unit 20 includes a solvent sensor 72 that is attached to the bottom wall 62 of the solvent housing 54 such that the solvent sensor 72 is positioned inside of the solvent housing 54. The solvent 22 actuator is electrically coupled to the processing circuit 32 and the solvent sensor 72 senses when the tray 69 and the chopped pieces 18 are positioned in the solvent housing 54. The solvent sensor 72 may comprise an optical sensor or other type of electronic sensor that is capable of sensing the presence of the tray 69 and the chopped pieces 18 in the solvent housing 54.

The solvent bath unit 20 includes a solvent lift panel 80 which has a coupled end 82 and a free end 84 and the free end 84 of the solvent lift panel 80 is hingedly coupled to the bottom wall 62 of the solvent housing 54. The solvent lift panel 80 is positionable in a first position having the solvent lift panel 80 lying on a plane that is oriented parallel to the bottom wall 62 of the solvent housing 54. In this way the tray 69 and the chopped pieces 18 lie on the solvent lift panel 80 when the tray 69 and the chopped pieces 18 are submerged in the solvent 22. The solvent lift panel 80 is positionable in a second position having the solvent lift panel 80 being oriented in a vertical position such that the solvent lift panel 80 pivots toward the exit 66 in the front wall 56 of the solvent housing 54. In this way the solvent lift panel 80 can urge the tray 69 and the chopped pieces 18 through the exit 66. Furthermore, the solvent 22 panel is foraminous thereby facilitating the solvent 22 to pass through the solvent lift panel 80 when the solvent 22 panel is urged into the second position for retaining the solvent 22 in the solvent housing 54.

The solvent bath unit 20 includes a solvent lift panel actuator 86 which is attached to the solvent lift panel 80. The solvent lift panel actuator 86 is electrically coupled to the processing circuit 32 and the solvent lift panel actuator 86 is actuated into a lifting condition when the processing circuit 32 receives the solvent lift input. Furthermore, the solvent lift panel 80 is tilted into the second position thereby facilitating the tray 69 and the chopped pieces 18 to be urged outwardly through the exit 66 in the front wall 56 when the solvent 22 lift actuator is actuated into the lifting condition. The solvent lift panel actuator 86 is actuated into a lowering condition when the solvent lift panel actuator 86 has been in the lifting condition for a sufficient duration of time to fully tilt the solvent lift panel 80 into the vertical position thereby positioning the solvent lift panel 80 in the first position. Additionally, the processing circuit 32 receives the solvent lift input when the solvent sensor 72 senses the tray 69 and the chopped pieces 18.

The conveyor unit 24 comprises a conveyor pan 88 which has a forward end 90 and a rearward end 92 and a perimeter wall 94. The rearward end 92 is coupled to the front wall 56 of the solvent housing 54 of the solvent 22 bath at a point that is aligned with the bottom wall 62 of the solvent housing 54. The conveyor pan 88 is positioned beneath the exit 66 in the front wall 56 of the solvent housing 54. The conveyor unit 24 includes a first conveyor belt 96 that is rotatably integrated into the conveyor pan 88 such that the first conveyor belt 96 extends between the forward end 90 and the rearward end 92 of the conveyor pan 88. The tray 69 and the chopped pieces 18 are deposited onto the first conveyor belt 96 when the solvent lift panel actuator 86 tilts the solvent lift panel 80 into the vertical position.

The conveyor unit 24 includes a conveyor motor 98 which is attached to the conveyor pan 88 and the conveyor motor 98 is electrically coupled to the processing circuit 32. The conveyor motor 98 is in mechanical communication with the first conveyor belt 96 such that the conveyor motor 98 urges the first conveyor belt 96 to travel between the rearward end 92 and the forward end 90 of the conveyor pan 88 thereby transporting the tray 69 and the chopped pieces 18 from the rearward end 92 of the conveyor pan 88 to the forward end 90 of the conveyor pan 88 when the conveyor motor 98 is turned on. The conveyor motor 98 is electrically coupled to the processing circuit 32 and the conveyor motor 98 is turned on when the processing circuit 32 receives the first conveyor input. Furthermore, the processing circuit 32 receives the first conveyor input when the processing circuit 32 receives the solvent lift input.

The freezing unit 26 comprises a freezer housing 111 which has a forward end 112, a rearward end 113, a lower wall 114 and an upper wall 115; each of the forward end 112 and the rearward end 113 of the freezer housing 111 is open. The freezer housing 111 has a chute 116 extending rearwardly from the rearward end 113 of the freezer housing 111 at a point which is aligned with the lower wall 114 of the freezer housing 111. Additionally, the chute 116 is attached to the forward end 90 of the conveyor pan 88 of the conveyor unit 24 such that the lower wall 114 of the freezer housing 111 lies on a plane that is coplanar with the basal wall 108 of the conveyor pan 88. In this way the forward end 90 can receive the tray 69 and the chopped pieces 18 from the water lift panel 98.

The freezing unit 26 includes a second conveyor belt 117 which is movably disposed on the lower wall 114 of the freezer housing 111 such that the second conveyor belt 117 extends substantially between the forward end 112 and the rearward end 113 of the freezer housing 111. The second conveyor belt 117 is positioned inside of the freezer housing 111 such that the tray 69 and the chopped pieces 18 are deposited upon the second conveyor belt 117. The second conveyor belt 117 includes a drive 118 which is electrically coupled to the processing circuit 32 and the drive 118 is actuated to rotate the second conveyor belt 117 when the processing circuit 32 receives the freezing actuate input. In this way the second conveyor belt 117 transports the tray 69 and the chopped pieces 18 from the rearward end 113 of the freezer housing 111 toward the forward end 112 of the freezer housing 111. The drive 118 is de-actuated when the processing circuit 32 receives the freezing de-actuate input and the processing circuit 32 receives the heating de-actuate input after a sufficient duration of time for the second conveyor belt 117 to have transported the tray 69 and the chopped pieces 18 outwardly through the forward end 112 of the freezer housing 111. Additionally, the duration of time for the second conveyor belt 117 to be actuated may range between approximately 5.0 minutes and 10.0 minutes.

The freezing unit 26 includes a freezer 119 that is integrated into the upper wall 115 of the freezer housing 111 such that the freezer 119 is in thermal communication with an interior of the freezer housing 111. The freezer 119 is electrically coupled to the processing circuit 32 and the freezer 119 is turned on when the processing circuit 32 receives the freezing actuate input. Furthermore, the freezer 119 freezes the tray 69 and the chopped pieces 18 on the second conveyor belt 117 when the freezer 119 is turned on. In this way the solvent 22 and the tray 69 and the chopped pieces 18 are frozen for subsequent processing. The freezer 119 is turned off when the processing circuit 32 receives the freezing de-actuate input. Additionally, the freezer 119 may comprise an electric freezer which may have an operational temperature ranging between approximately −15.0 degrees Fahrenheit and 0.0 degrees Fahrenheit to facilitate the solvent and the tray and the chopped pieces to be freeze dried in a timely manner.

The grinding unit 28 comprises a duct 120 which has a back end 121 and a bottom end 122 and the duct 120 has a bend 123 which defines a first portion 124 of the duct 120 that is perpendicularly oriented with a second portion 125 of the duct 120. The back end 121 is associated with the first portion 124 and the bottom end 122 is associated with the second portion 125. Each of the back end 121 and the bottom end 122 is open and the duct 120 is flared adjacent to the bottom end 122 such that the bottom end 122 has dimensions that are greater than dimensions of the back end 121. Additionally, the back end 121 is coupled to the forward end 112 of the freezer housing 111 of the freezing unit 26 such that the back end 121 receives the tray 69 and the chopped pieces 18 from the forward end 112 of the freezer housing 111. Furthermore, the duct 120 is oriented such that the second portion 125 of the duct 120 extends downwardly thereby facilitating the tray 69 and the chopped pieces 18 the be gravity fed through the duct 120.

The grinding unit 28 includes a plurality of grinding blades 126 and each of the plurality of grinding blades 126 is rotatably disposed in the second portion 125 of the duct 120. Each of the plurality of grinding blades 126 is oriented to extend across the bottom end 122 of the duct 120 thereby forcing the tray 69 and the chopped pieces 18 to pass through the plurality of grinding blades 126 prior to passing through the bottom end 122 of the duct 120. The plurality of grinding blades 126 may comprise cylindrical rollers that have a plurality of cutting edges or auger style screws or any other type of cutting device that is capable of grinding the tray 69 and the chopped pieces 18 into granules that have a maximum diameter ranging between approximately 1.5 mm and 3.0 mm.

The grinding unit 28 includes a blade drive 128 that is integrated into the second portion 125 of the duct 120. The blade drive 128 is in mechanical communication with each of the plurality of grinding blades 126 such that the blade drive 128 rotates the plurality of grinding blades 126 when the blade drive 128 is turned on. In this way the plurality of grinding blades 126 can grind the tray 69 and the chopped pieces 18 into the granular material 30 having the granular material 30 exiting the duct 120 through the bottom end 122 of the duct 120. Thus, the grinding blades 126 facilitate the granular material 30 to occupy as little space as possible in the waste management facility. The blade drive 128 is electrically coupled to the processing circuit 32 and the blade drive 128 is turned on when the processing circuit 32 receives the grinding input. Conversely, the blade drive 128 is turned off when the blade drive 128 has been turned on a sufficient duration of time to fully grind the tray 69 and the chopped pieces 18.

A series of legs is 130 provided and each of the series of legs 130 is attached to and extends downwardly from the processing plant 12 thereby facilitating the processing plant 12 to be elevated above a support surface 131. The support surface 131 may be a floor in an industrial facility or other type of horizontal support surface located in a facility that processes municipal waste, for example, or other type of facility that specializes in processing extruded polystyrene 16. Each of the series of legs 130 has a telescopically adjustable length for adjusting the height and positioning of the processing plant 12 and each of the series of legs 130 includes a foot 132 that rests on the support surface 131. The hopper 36 of the chopping unit 14 may be fed by a second conveyor belt, for example, or the hopper 36 of the chopping unit 14 may be manually fed by a worker. Additionally, the duct 120 of the grinding unit 28 may be directed toward a bed of a truck, for example, or other type of containment intended for transporting the granular material 30 to a waste management facility.

In use, the items of extruded polystyrene 16 are fed into the hopper 36 of the chopping unit 14 for processing the items of extruded polystyrene 16. The chopping unit 14 chops the items of extruded polystyrene 16 into the chopped pieces 18 for subsequent reduction in the solvent bath unit 20. Furthermore, a tray 69 is loaded onto the tray ramp 65 such that the tray 69 slides into the solvent bath unit 20 to facilitate the chopped pieces to be collected on the tray 69. The tray 69 and the chopped pieces 18 are fed into the freezing unit 26 to be frozen and the tray 69 and the chopped pieces 18 are fed into the grinding unit 28 to grind the tray 69 and the chopped pieces 18 into the granular material 30 which can be collected and transported to a waste management facility, such a landfill for example. In this way the granular material 30 occupies far less space in the waste management facility than would the unprocessed items of extruded polystyrene 16. Furthermore, the granular material 30 can be collected and employed for various recycling purposes or other means of reusing the polystyrene.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extruded polystyrene processing device for reducing extruded polystyrene into a granular material for subsequent delivery to a waste management facility, said device comprising:
a processing plant including a chopping unit for chopping extruded polystyrene into chopped pieces, said chopping unit being connected to a solvent bath unit for submerging said chopped pieces in a solvent for eliminating air bubbles in said chopped pieces, said solvent bath unit being connected to a conveyor unit which receives said chopped pieces for transporting the solvent from said chopped pieces, said conveyor unit being connected to a freezing unit which receives said chopped pieces from said conveyor unit to subsequently freeze said chopped pieces, said freezing unit being connected to a grinding unit which receives said frozen chopped pieces for grinding said frozen chopped pieces into a granular material for subsequent collection and transportation to a waste management facility wherein said processing plant is configured to reduce the total volume of the extruded polystyrene prior to being handled by the waste management facility thereby reducing the environmental impact of the extruded polystyrene.

2. The device according to claim 1, wherein:
said processing plant includes a processing circuit;
said processing circuit receives a chop input;
said processing circuit receives a door open input;
said processing circuit receives a door close input;
said processing circuit receives a solvent lift input;
said processing circuit receives a first conveyor input;
said processing circuit receives a second conveyor input;
said processing circuit receives a freezing actuate input;
said processing circuit receives a freezing de-actuate input;
said processor receives a grinding input; and
said processing circuit is electrically coupled to a power source.

3. The device according to claim 1, wherein:
said chopping unit comprises a hopper having a first end and a second end and an outer wall extending between said first end and said second end;
said hopper is substantially hollow;
each of said first end and said second end is open; and
said outer wall undulates between said first end and said second end such that said hopper defines an S-shape having said first end being spaced upwardly from said second end wherein said first end is configured to receive items of extruded polystyrene such that said undulation of said outer wall facilitates the items of extruded polystyrene to be gravity fed toward said second end.

4. The device according to claim 3, wherein:
said processing plant includes a processing circuit;
said processing circuit receives a chop input;
said chopping unit includes a chopper being movably integrated within said hopper;
said chopper is electrically coupled to said processing circuit;
said chopper is turned on when said processing circuit receives said chop input;
said chopper is positioned closer to said first end than said second end; and
said chopper includes a series of blades which are rotated when said chopper is turned on thereby facilitating said chopper to chop the items of extruded polystyrene into said chopped pieces.

5. The device according to claim 4, wherein:
said chopping unit includes a sensor being positioned within said hopper;
said sensor is positioned closer to said second end of said hopper than said chopper;
said sensor is electrically coupled to said processing circuit;
said sensor senses the volume of chopped pieces in said hopper;
said processing circuit receives a door open input when said sensor determines that the volume of said chopped pieces in said hopper exceeds a pre-determined trigger volume;
said pre-determined trigger volume is a volume of approximately 80.0 percent of the internal area in said hopper which is located between said chopper and said second end of said hopper; and
said processing circuit receives a door close input when said sensor determines that the volume of said chopped pieces in said hopper does not exceed said pre-determined trigger volume.

6. The device according to claim 3, wherein:
said chopping unit includes a door being slidably integrated into said second end of said hopper;
said door is oriented to lie on a plane being oriented parallel to said second end of said hopper;
said door is positionable in a closed position having said door lying against said second end for closing said second end thereby inhibiting said chopped pieces from passing through said second end and exiting said hopper; and
said door is positionable in an open position having said door being lifted upwardly to expose said second end thereby facilitating said chopped pieces to pass through said second end to exit said hopper.

7. The device according to claim 6, wherein:
said processing plant includes a processing circuit;
said processing circuit receives a door close input and a door open input; and
said chopping unit includes a door actuator being integrated into said hopper;
said door actuator is electrically coupled to said processing circuit;
said door actuator is in mechanical communication with said door;
said door actuator is actuated into a closing condition when said processing circuit receives said door close input thereby urging said door into said closed position;
said door actuator is actuated into an open condition when said processing circuit receives said door open input thereby urging said door into said open position.

8. The device according to claim 6, wherein:
said solvent bath unit comprises a solvent housing having a front wall and a back wall and a top wall and a bottom wall;
said solvent housing has an entrance extending through said back wall;
said solvent housing has an exit extending through said front wall;
each of said exit and said entrance is spaced upwardly from said bottom wall;
said second end of said hopper is attached to said back wall of said solvent housing having said second end being aligned with said entrance thereby facilitating said chopped pieces to pass through said entrance when said door is urged into said open position;
said solvent housing has a drain being integrated into said bottom wall thereby facilitating said drain to drain a solvent contained in said solvent housing;
said solvent is filled to a level that is below each of said entrance and said exit in said solvent housing thereby facilitating said solvent housing to contain said solvent;
said solvent housing has a spray nozzle extending through said top wall of said solvent housing; and
said spray nozzle is in fluid communication with said drain thereby facilitating said spray nozzle to spray said solvent into said solvent housing for recirculating said solvent in said solvent housing.

9. The device according to claim 8, wherein:
said processing plant includes a processing circuit;
said solvent bath unit includes a tray ramp being coupled to and angling upwardly and rearwardly from said back wall of said solvent housing;
said tray ramp is aligned with a tray opening in said back wall of said solvent housing thereby facilitating a tray which is placed on said tray ramp to slide through said tray opening and into said solvent housing such that said chopped pieces are deposited into said tray;
said tray has a plurality of drain holes each extending through a bottom wall of said tray thereby facilitating said solvent to drain through each of said plurality of drain holes;
said solvent bath unit includes a solvent sensor being attached to said bottom wall of said solvent housing such that said solvent sensor is positioned inside of said solvent housing; and
said solvent sensor senses when said tray and said chopped pieces are positioned in said solvent housing.

10. The device according to claim 8, wherein:
said solvent bath unit includes a solvent lift panel having a coupled end and a free end;
said free end of said solvent lift panel is hingedly coupled to said bottom wall of said solvent housing;
said solvent lift panel is positionable in a first position having said solvent lift panel lying on a plane being oriented parallel to said bottom wall of said solvent housing thereby facilitating said tray and said chopped pieces to lie on said solvent lift panel when said tray and said chopped pieces are submerged in said solvent;
said solvent lift panel has a foot extending upwardly from said solvent lift panel at a point being aligned with said free end of said solvent lift panel for retaining said tray on said solvent lift panel;
said solvent lift panel is positionable in a second position having said solvent lift panel being oriented in a vertical position having said solvent lift panel pivoting toward said exit in said front wall of said solvent housing thereby facilitating said solvent lift panel to urge said tray and said chopped pieces through said exit; and
said solvent panel is foraminous thereby facilitating said solvent to pass through said solvent lift panel when said solvent panel is urged into said second position for retaining said solvent in said solvent housing.

11. The device according to claim 10, wherein:
said processing plant includes a processing circuit;
said processing circuit receives a solvent lift input;
said solvent bath includes a solvent lift panel actuator being attached to said solvent lift panel;
said solvent lift panel actuator is electrically coupled to said processing circuit;
said solvent lift panel actuator is actuated into a lifting condition when said processing circuit receives said solvent lift input;
said processing circuit receiving said solvent lift input when said solvent sensor senses said tray and said chopped pieces;
said solvent lift panel has a foot extending upwardly from said solvent lift panel at a point being aligned with said free end of said solvent lift panel for retaining said tray on said solvent lift panel;
said solvent lift panel is tilted into said second position thereby facilitating said tray and said chopped pieces to be urged outwardly through said exit in said front wall when said solvent lift actuator is actuated into said lifting condition; and
said solvent lift panel actuator is actuated into a lowering condition when said solvent lift panel actuator has been in said lifting condition for a sufficient duration of time to fully tilt said solvent lift panel into said vertical position thereby positioning said solvent lift panel in said first position.

12. The device according to claim 9, wherein:
said conveyor unit comprises a pan having a forward end and a rearward end and a perimeter wall;
said rearward end is coupled to said front wall of said solvent housing of said solvent bath at point being aligned with said bottom wall of said solvent housing having said pan being positioned beneath said exit in said front wall of said solvent housing;
said conveyor unit includes a first conveyor belt being rotatably integrated into said conveyor pan such that said first conveyor belt extends between said forward end and said rearward end of said conveyor pan, said tray being deposited onto said first conveyor belt when said solvent lift actuator tilts said solvent lift panel into said vertical position;
said conveyor unit includes a conveyor motor being attached to said conveyor pan;
said conveyor motor is electrically coupled to said processing circuit;
said processing circuit receiving a solvent lift input;
said processing circuit receiving a first conveyor input;
said conveyor motor is in mechanical communication with said first conveyor belt such that said conveyor motor urges said conveyor belt to travel between said rearward end and said forward end of said conveyor pan thereby transporting said tray from said rearward end of said conveyor pan to said forward end of said conveyor pan when said conveyor motor is turned on;
said conveyor motor is turned on when said processing circuit receives said first conveyor input; and
said processing circuit receives said first conveyor input when said processing circuit receives said solvent lift input.

13. The device according to claim 12, wherein:
said processing circuit receives a freezing actuate input and a freezing de-actuate input;
said freezer unit includes a freezer housing having a forward end and a rearward end and a lower wall and an upper wall;
each of said forward end and said rearward end of said freezer housing is open;
said rearward end of said freezer housing is attached to said forward end of said conveyor pan such that said rearward end of said freezer housing receives said tray from said first conveyor belt;
said freezing unit includes a second conveyor belt being movably disposed on said lower wall of said freezer housing such that said second conveyor belt extends substantially between said forward end and said rearward end of said freezer housing;
said second conveyor belt is positioned inside of said freezer housing such that said chopped pieces are deposited upon said second conveyor belt;
said second conveyor belt includes a drive being electrically coupled to said processing circuit;
said drive is actuated to rotate said second conveyor belt when said processing circuit receives said freezing actuate input thereby facilitating said second conveyor belt to transport tray and said chopped pieces from said rearward end of said freezer housing toward said forward end of said freezer housing;
said drive is de-actuated when said processing circuit receives said freezing de-actuate input; and
said processing circuit receives said heating de-actuate input after a sufficient duration of time for said second conveyor belt to have transported said tray and said chopped pieces outwardly through said forward side of said freezer housing.

14. The device according to claim 13, wherein:
said freezing unit includes a freezer being integrated into said upper wall of said freezer housing such that said freezer is in thermal communication with an interior of said freezer housing;
said freezer is electrically coupled to said processing circuit;
said freezer is turned on when said processing circuit receives said freezing actuate input;
said freezer freezes said tray and said chopped pieces on said second conveyor belt when said freezer is turned on for freezing said water that remains on said tray and said chopped pieces; and
said freezer is turned off when said processing circuit receives said freezing de-actuate input.

15. The device according to claim 13, wherein:
said grinding unit comprises a duct having a back end and a bottom end;
said duct has a bend defining a first portion of said duct being perpendicularly oriented with a second portion of said duct;
said back end is associated with said first portion;
said bottom end being associated with said second portion;
each of said back end and said bottom end is open;
said duct is flared adjacent to said bottom end such that said bottom end has dimensions being greater than dimensions of said back end;
said back end is coupled to said forward end of said freezer housing of said freezing unit such that said back end receives said tray and said chopped pieces from said forward end of said freezer housing; and
said duct is oriented such that said second portion of said duct extends downwardly thereby facilitating said tray and said chopped pieces the be gravity fed through said duct.

16. The device according to claim 15, wherein:
said processing circuit receives a grinding input;
said grinding unit includes a plurality of grinding blades;
each of said plurality of grinding blades is rotatably disposed in said second portion of said duct;
each of said plurality of grinding blades is oriented to extend across said bottom end of said duct thereby forcing said tray and said chopped pieces to pass through said plurality of blades prior to passing through said bottom end of said duct;
said grinding unit includes a blade drive being integrated into said second portion of said duct;
said blade drive is in mechanical communication with each of said plurality of grinding blades such that said blade drive rotates said plurality of grinding blades when said blade drive is turned on thereby facilitating said plurality of grinding blades to grind said tray and said chopped pieces into granular material having the granular material exiting said duct through said bottom end of said duct wherein said grinding blades are configured to facilitate the granular material to occupy as little space as possible in the waste management facility; and
said blade drive is electrically coupled to said processing circuit, said blade drive being turned on when said processing circuit receives said grinding input, said blade drive being turned off when said blade drive has been turned on a sufficient duration of time to fully grind said chopped pieces.

17. An extruded polystyrene processing device for reducing extruded polystyrene into a granular material for subsequent delivery to a waste management facility, said device comprising:
a processing plant including a chopping unit for chopping extruded polystyrene into chopped pieces, said chopping unit being connected to a solvent bath unit for submerging said chopped pieces in a solvent for eliminating air bubbles in said chopped pieces, said solvent bath unit being connected to a conveyor unit which receives said chopped pieces for transporting the solvent from said chopped pieces, said conveyor unit being connected to a freezing unit which receives said chopped pieces from said conveyor unit to subsequently freeze and dry said chopped pieces, said freezing unit being connected to a grinding unit which receives the frozen and dried chopped pieces for grinding the frozen and dried chopped pieces into a granular material for subsequent collection and transportation to a waste management facility wherein said processing plant is configured to reduce the total volume of the extruded polystyrene prior to being handled by the waste management facility thereby reducing the environmental impact of the extruded polystyrene;
wherein said processing plant includes a processing circuit, said processing circuit receiving a chop input, said processing circuit receiving a door open input, said processing circuit receiving a door close input, said processor receiving a solvent lift input, said processing circuit receiving a first conveyor input, said processing circuit receiving a second conveyor input, said processing circuit receiving a freezing actuate input, said processing circuit receiving a freezing de-actuate input, said processor receiving a grinding input, said processing circuit being electrically coupled to a power source;
wherein said chopping unit comprises:
a hopper having a first end and a second end and an outer wall extending between said first end and said second end, said hopper being substantially hollow, each of said first end and said second end being open, said outer wall undulating between said first end and said second end such that said hopper defines an S-shape having said first end being spaced upwardly from said second end wherein said first end is configured to receive items of extruded polystyrene such that said undulation of said outer wall facilitates the items of extruded polystyrene to be gravity fed toward said second end;
a chopper being movably integrated within said hopper, said chopper being electrically coupled to said processing circuit, said chopper being turned on when said processing circuit receives said chop input, said chopper being positioned closer to said first end than said second end, said chopper including a series of blades which are rotated when said chopper is turned on thereby facilitating said chopper to chop the items of extruded polystyrene into said chopped pieces;
a sensor being positioned within said hopper, said sensor being positioned closer to said second end of said hopper than said chopper, said sensor being electrically coupled to said processing circuit, said sensor sensing the volume of chopped pieces in said hopper, said processing circuit receiving said door open input when said sensor determines that the volume of said chopped pieces in said hopper exceeds a pre-determined trigger volume, said pre-determined trigger volume being a volume of approximately 80.0 percent of the internal area in said hopper which is located between said chopper and said second end of said hopper, said processing circuit receiving said door close input when said sensor determines that the volume of said chopped pieces in said hopper does not exceed said pre-determined trigger volume;
a door being slidably integrated into said second end of said hopper, said door being oriented to lie on a plane being oriented parallel to said second end of said hopper, said door being positionable in a closed position having said door lying against said second end for closing said second end thereby inhibiting said chopped pieces from passing through said second end and exiting said hopper, said door being positionable in an open position having said door being lifted upwardly to expose said second end thereby facilitating said chopped pieces to pass through said second end to exit said hopper; and
a door actuator being integrated into said hopper, said door actuator being electrically coupled to said processing circuit, said door actuator being in mechanical communication with said door, said door actuator being actuated into a closing condition when said processing circuit receives said door close input thereby urging said door into said closed position, said door actuator being actuated into an open condition when said processing circuit receives said door open input thereby urging said door into said open position;
wherein said solvent bath comprises:
a solvent housing having a front wall and a back wall and a top wall and a bottom wall, said solvent housing having an entrance extending through said back wall, said solvent housing having an exit extending through said front wall, each of said exit and said entrance being spaced upwardly from said bottom wall, said second end of said hopper being attached to said back wall of said solvent housing having said second end being aligned with said entrance thereby facilitating said chopped pieces to pass through said entrance when said door is urged into said open position, said solvent housing having a drain being integrated into said bottom wall thereby facilitating said drain to drain a solvent contained in said solvent housing, said solvent being filled to a level that is below each of said entrance and said exit in said solvent housing thereby facilitating said solvent housing to contain said solvent, said solvent housing having a spray nozzle extending through said top wall of said solvent housing, said spray nozzle being in fluid communication with said drain thereby facilitating said spray nozzle to spray said solvent into said solvent housing for recirculating said solvent in said solvent housing;
a tray ramp being coupled to and angling upwardly and rearwardly from said back wall of said solvent housing, said tray ramp being aligned with a tray opening in said back wall of said solvent housing thereby facilitating a tray which is placed on said tray ramp to slide through said tray opening and into said solvent housing such that said chopped pieces are deposited into said tray, said tray having a plurality of drain holes each extending through a bottom wall of said tray thereby facilitating said solvent to drain through each of said plurality of drain holes;
a solvent sensor being attached to said bottom wall of said solvent housing such that said solvent sensor is positioned inside of said solvent housing, said solvent actuator being electrically coupled to said processing circuit, said solvent sensor sensing when said chopped pieces are positioned in said solvent housing;
a solvent lift panel having a coupled end and a free end, said free end of said solvent lift panel being hingedly coupled to said bottom wall of said solvent housing, said solvent lift panel being positionable in a first position having said solvent lift panel lying on a plane being oriented parallel to said bottom wall of said solvent housing thereby facilitating said tray to rest on said solvent lift panel when said tray is slid into said solvent housing thereby submerging said tray and said chopped pieces in said solvent, said solvent lift panel having a foot extending upwardly from said solvent lift panel at a point being aligned with said free end of said solvent lift panel for retaining said tray on said solvent lift panel, said solvent lift panel being positionable in a second position having said solvent lift panel being oriented in a vertical position having said solvent lift panel pivoting toward said exit in said front wall of said solvent housing thereby facilitating said solvent lift panel to urge said tray and said chopped pieces through said exit, said solvent panel being foraminous thereby facilitating said solvent to pass through said solvent lift panel when said solvent panel is urged into said second position for retaining said solvent in said solvent housing; and
a solvent lift panel actuator being attached to said solvent lift panel, said solvent lift panel actuator being electrically coupled to said processing circuit, said solvent lift panel actuator being actuated into a lifting condition when said processing circuit receives said solvent lift input, said processing circuit receiving said solvent lift input when said solvent sensor senses said tray and said chopped pieces, said solvent lift panel being tilted into said second position thereby facilitating said tray to be urged outwardly through said exit in said front wall when said solvent lift actuator is actuated into said lifting condition, said solvent lift panel actuator being actuated into a lowering condition when said solvent lift panel actuator has been in said lifting condition for a sufficient duration of time to fully tilt said solvent lift panel into said vertical position thereby positioning said solvent lift panel in said first position;
said conveyor unit comprises:
a conveyor pan having a forward end and a rearward end, said rearward end is coupled to said front wall of said solvent housing of said solvent bath at point being aligned with said bottom wall of said solvent housing having said pan being positioned beneath said exit in said front wall of said solvent housing;
a first conveyor belt being rotatably integrated into said conveyor pan such that said first conveyor belt extends between said forward end and said rearward end of said conveyor pan, said tray being deposited onto said first conveyor belt when said solvent lift actuator tilts said solvent lift panel into said vertical position;
a conveyor motor being attached to said conveyor pan, said conveyor motor being electrically coupled to said processing circuit, said conveyor motor being in mechanical communication with said first conveyor belt such that said conveyor motor urges said conveyor belt to travel between said rearward end and said forward end of said conveyor pan thereby transporting said tray from said rearward end of said conveyor pan to said forward end of said conveyor pan when said conveyor motor is turned on, said conveyor motor being electrically coupled to said processing circuit, said conveyor motor being turned on when said processing circuit receives said first conveyor input, said processing circuit receiving said first conveyor input when said processing circuit receives said solvent lift input;
wherein said freezing unit comprises:
a freezer housing having a forward end and a rearward end and a lower wall and an upper wall, each of said forward end and said rearward end of said freezer housing being open, said rearward end of said freezer housing being attached to said forward end of said conveyor pan such that said rearward end of said freezer housing receives said tray and said chopped pieces from said first conveyor belt;
a second conveyor belt being movably disposed on said lower wall of said freezer housing such that said second conveyor belt extends substantially between said forward end and said rearward end of said freezer housing, said second conveyor belt being positioned inside of said freezer housing such that said tray and said chopped pieces are deposited upon said second conveyor belt, said second conveyor belt including a drive being electrically coupled to said processing circuit, said drive being actuated to rotate said second conveyor belt when said processing circuit receives said freezing actuate input thereby facilitating said second conveyor belt to transport said tray and said chopped pieces from said rearward end of said freezer housing toward said forward end of said freezer housing, said drive being de-actuated when said processing circuit receives said freezing de-actuate input, said processing circuit receiving said heating de-actuate input after a sufficient duration of time for said second conveyor belt to have transported said tray and said chopped pieces outwardly through said forward side of said freezer housing; and
a freezer being integrated into said upper wall of said freezer housing such that said freezer is in thermal communication with an interior of said freezer housing, said freezer being electrically coupled to said processing circuit, said freezer being turned on when said processing circuit receives said freezing actuate input, said freezer freezing said tray and said chopped pieces on said second conveyor belt when said freezer is turned on for freezing said water that remains on said tray and said chopped pieces, said freezer being turned off when said processing circuit receives said freezing de-actuate input; and
wherein said grinding unit comprises:
a duct having a back end and a bottom end, said duct having a bend defining a first portion of said duct being perpendicularly oriented with a second portion of said duct, said back end being associated with said first portion, said bottom end being associated with said second portion, each of said back end and said bottom end being open, said duct being flared adjacent to said bottom end such that said bottom end has dimensions being greater than dimensions of said back end, said back end being coupled to said forward end of said freezer housing of said freezing unit such that said back end receives said tray and said chopped pieces from said forward end of said freezer housing, said duct being oriented such that said second portion of said duct extends downwardly thereby facilitating said tray and said chopped pieces the be gravity fed through said duct;
a plurality of grinding blades, each of said plurality of grinding blades being rotatably disposed in said second portion of said duct, each of said plurality of grinding blades being oriented to extend across said bottom end of said duct thereby forcing said tray and said chopped pieces to pass through said plurality of blades prior to passing through said bottom end of said duct; and
a blade drive being integrated into said second portion of said duct, said blade drive being in mechanical communication with each of said plurality of grinding blades such that said blade drive rotates said plurality of grinding blades when said blade drive is turned on thereby facilitating said plurality of grinding blades to grind said tray and said chopped pieces into a granular material having said granular material exiting said duct through said bottom end of said duct wherein said grinding blades are configured to facilitate said granular material to occupy as little space as possible in the waste management facility, said blade drive being electrically coupled to said processing circuit, said blade drive being turned on when said processing circuit receives said grinding input, said blade drive being turned off when said blade drive has been turned on a sufficient duration of time to fully grind said tray and said chopped pieces.
